(19) United States
(12) Patent Application Publication
(10) Pub. No.: US 2019/0176117 A1
(43) Pub. Date: Jun. 13, 2019

(54) WEBBING TAKE-UP DEVICE AND METHOD OF MANUFACTURING THEREOF

(71) Applicant: KABUSHIKI KAISHA TOKAI-RIKA-DENKI-SEISAKUSHO, Aichi (JP)

(72) Inventors: Masanori UKAI, Aichi (JP); Taku YAMADA, Aichi (JP)

(21) Appl. No.: 16/309,180

(22) PCT Filed: Jun. 8, 2017
(86) PCT No.: PCT/JP2017/021375

§ 371 Date: Dec. 12, 2018

(30) Foreign Application Priority Data
Jun. 21, 2016 (JP) 2016-122764

(51) Int. Cl. B01J 7/00; B60R 22/46

(52) U.S. Cl. CPC B01J 7/00; B60R 2022/4642; B60R 22/46

(57) ABSTRACT

A webbing take-up device has a pretensioner mechanism that rotates a spool in a take-up direction owing to a micro-gas generator being operated at a time of an emergency of a vehicle. A micro-gas generator mounting portion of the pretensioner mechanism is formed in a shape of a tube into which the micro-gas generator is inserted. The micro-gas generator mounting portion has recessed portions, whose micro-gas generator sides are open, and convex portions that are formed along the recessed portions, and that are formed in shapes that are convex toward the micro-gas generator side, and on which a portion of the micro-gas generator is anchored.

### TECHNICAL FIELD

The present invention relates to a webbing take-up device and a method of manufacturing thereof.

### BACKGROUND ART

A webbing take-up device that has a spool, at which a webbing that is worn by a vehicle occupant is taken up, and a pretensioner, which eliminates slack of the webbing at the time of an emergency of the vehicle, is disclosed in Japanese Patent Application Laid-Open (JP-A) No. 2012-35748. Further, the pretensioner is configured to include a gas generator that generates gas when operated, a pipe to whose interior the gas generated by the gas generator is supplied, and a driving force transmitting member that is disposed within the pipe. Further, due to gas that is generated by the gas generator being supplied into the pipe and the driving force transmitting member being moved, the spool can be rotated in the take-up direction.

By the way, a wire that is provided at the vehicle side is connected to the gas generator. Therefore, at the time of mounting the gas generator to the pipe, it is desirable that displacement of the gas generator with respect to the pipe be restricted. Thus, in the webbing take-up device described in JP-A No. 2012-35748, displacement of the gas generator with respect to the pipe is restricted due to a portion of the gas generator being press-fit into the pipe while being deformed by a pair of projections that are provided at the pipe.

### SUMMARY OF INVENTION

### Technical Problem

In view of the above-described circumstances, an object of the present invention is to provide a webbing take-up device that can restrict displacement of a gas generating device with respect to a gas generating device mounting portion, and a method of manufacturing the webbing take-up device.

### Solution to Problem

A webbing take-up device of a first aspect of the present disclosure comprises: a spool at which a webbing, which is worn by a vehicle occupant, is taken up by the spool being rotated in a take-up direction; and a pretensioner mechanism that has a gas generating device that is configured to generate gas when operated, and a gas generating device mounting portion, that is formed in a shape of a tube into which the gas generating device is inserted and that is provided with a recessed portion that is open toward a side of the gas generating device and a convex portion that is formed along the recessed portion and is convexly-shaped toward the side of the gas generating device and at which a portion of the gas generating device is anchored, the pretensioner mechanism rotating the spool in the take-up direction owing to the gas generating device being operated at a time of an emergency of a vehicle.

A method of manufacturing a webbing take-up device of a second aspect of the present disclosure is applied to the manufacturing of the webbing take-up device of the first aspect. This method of manufacturing a webbing take-up device comprises: using a die that supports a pipe formed in a tube shape, a first punch that is formed in a shape corresponding to an external shape of the gas generating device, and a second punch having a portion formed in a shape corresponding to the recessed portion; forming a portion of the pipe into which the gas generating device can be inserted, by setting the pipe at the die and nipping the pipe between the die and the first punch; forming the gas generating device mounting portion of the pipe, which has the recessed portion and the convex portion, by inserting the second punch into the portion of the pipe into which the gas generating device can be inserted; and fixing the gas generating device to the gas generating device mounting portion by inserting the gas generating device into the gas generating device mounting portion.

### Advantageous Effects of Invention

In accordance with the webbing take-up device of the first aspect of the present disclosure, when the gas generating device is operated, the spool is rotated in the take-up direction, and the webbing is taken up by the spool. Here, in the invention of claim 1, recessed portions and convex portions are formed at the gas generating device mounting portion at which the gas generating device is mounted. The recessed portions are open toward a side of the gas generating device. The convex portions, which are convexly-shaped toward the side of the gas generating device, are formed along the recessed portions. Further, due to a portion of the gas generating device being anchored on the convex portions, displacement of the gas generating device with respect to the gas generating device mounting portion can be restricted.

In accordance with the method of manufacturing a webbing take-up device of the second aspect of the present disclosure, first, the pipe is set at the die, and the pipe is nipped-in between the die and the first punch. Due thereto, a portion into which the gas generating device can be inserted is formed in the pipe. Next, the second punch is inserted into the portion of the pipe, into which the gas generating device can be inserted. Due thereto, the recessed portions are formed at portions of the pipe, that are pushed by the second punch, and the convex portions are formed along these recessed portions. Namely, the gas generating device mounting portion, which has the recessed portions and the convex portions, is formed at the pipe. Next, the gas generating device is inserted into the gas generating device mounting portion, and the gas generating device is fixed to the gas generating device mounting portion. Here, in the state in which the gas generating device is inserted into the gas generating device mounting portion, displacement of the gas generating device with respect to the gas generating device mounting portion can be restricted by the convex portions that are formed at the gas generating device mounting portion.

### BRIEF DESCRIPTION OF DRAWINGS

FIG. 1 is a front view showing a webbing take-up device.

FIG. 2 is a cross-sectional view showing the cross-section of a pretensioner mechanism cut along line 2-2 shown in FIG. 1.

FIG. 3(1) is a cross-sectional view showing the cross-section of a gas generating device mounting portion, and FIG. 3(2) is a cross-sectional view showing the cross-section of the gas generating device mounting portion cut along line 3B-3B shown in FIG. 3(1).

FIGS. 4(1) through 4(4) are explanatory drawings for explaining steps of forming the gas generating device mounting portion at a pipe.

FIGS. 5(1) and 5(2) are cross-sectional views that correspond to FIGS. 3(1) and 3(2) and that show the gas generating device mounting portion having recessed portions and convex portions formed by a triangular punch.

### DESCRIPTION OF EMBODIMENTS

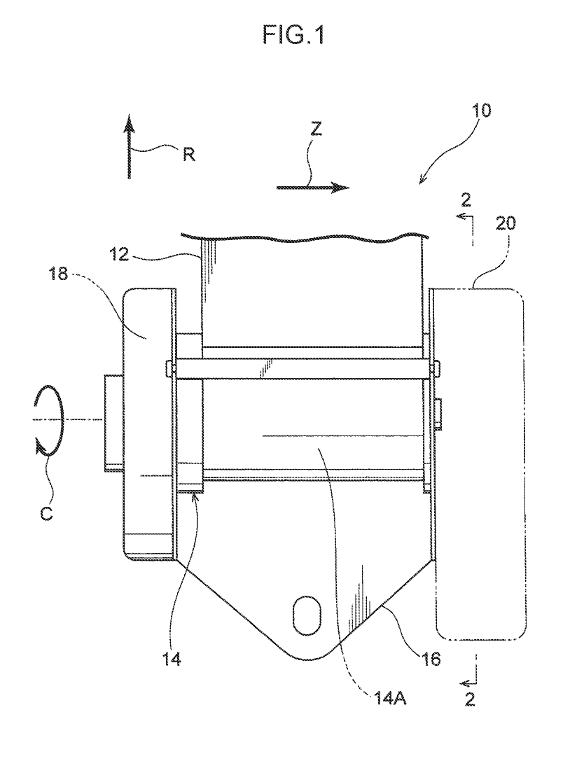

A webbing take-up device relating to an embodiment of the present invention is described by using FIG. 1 through FIG. 3. Note that the arrow Z direction, the arrow R direction and the arrow C direction that are shown appropriately in the drawings indicate the rotation axial direction, the rotation radial direction and the rotation peripheral direction of a spool, respectively. Hereinafter, when merely axial direction, radial direction and peripheral direction are used, they refer to the rotation axial direction, the rotation radial direction and the rotation peripheral direction of the spool, unless otherwise indicated.

As shown in FIG. 1, a webbing take-up device 10 of the present embodiment has a spool 14, at which a webbing 12, which is worn by a vehicle occupant, is taken up and that is rotated in a pull-out direction due to the webbing 12 being pulled-out, and a frame 16 that rotatably supports the spool 14. Further, the webbing take-up device 10 has a locking mechanism 18 that restricts rotation of the spool 14 in the pull-out direction at the time of an emergency of the vehicle (at a time of sudden pulling-out of the webbing 12 from the spool 14, or at a time of rapid deceleration of the vehicle, at a time of a collision of the vehicle or the like), and a pretensioner mechanism 20 that forcibly rotates the spool 14 in a take-up direction at the time of an emergency of the vehicle.

The spool 14 has a take-up portion 14A that is formed substantially in a cylindrical shape. The webbing 12, which is shaped as an elongated strip, is taken up onto the take-up portion 14A from the proximal end side of the webbing 12. The webbing 12 extends out from the frame 16 toward the upper side, and can be worn by a vehicle occupant who is seated in a seat (not illustrated) of the vehicle. Further, owing to the spool 14 being rotated toward a peripheral direction other side in the take-up direction (the opposite direction to the direction of arrow C), the webbing 12 is taken up onto the spool 14, and, due to the webbing 12 being pulled-out from the spool 14, the spool 14 is rotated toward a peripheral direction one side (in the arrow C direction), i.e., the spool 14 is rotated in the pull-out direction.

The locking mechanism 18, which restricts rotation of the spool 14 in the pull-out direction at the time of an emergency of the vehicle, is provided at an axial direction another side (the side opposite to the arrow Z direction) of the spool 14. Further, the pretensioner mechanism 20, which eliminates slack in the webbing 12 that is worn by the vehicle occupant by forcibly rotating the spool 14 in the take-up direction at the time of an emergency of the vehicle, is provided at an axial direction one side (the arrow Z direction side) of the spool 14.

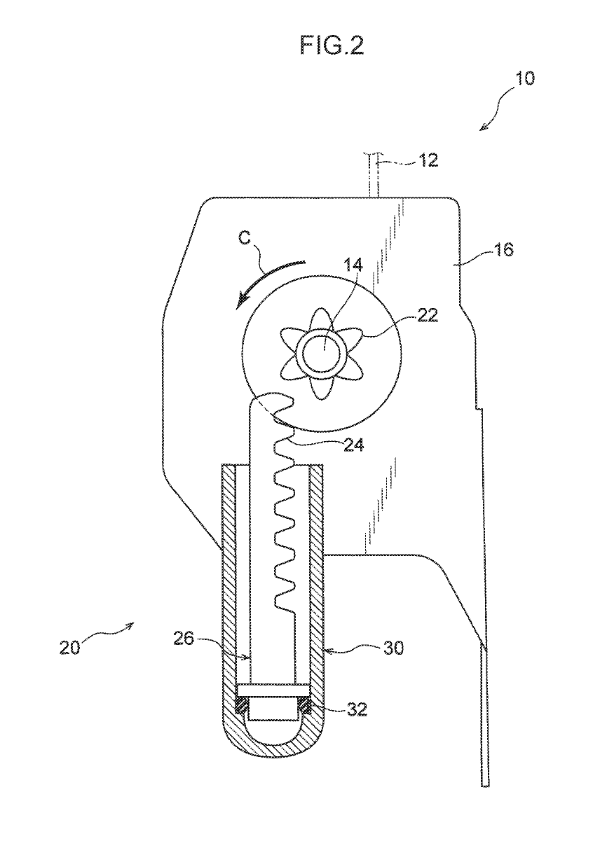

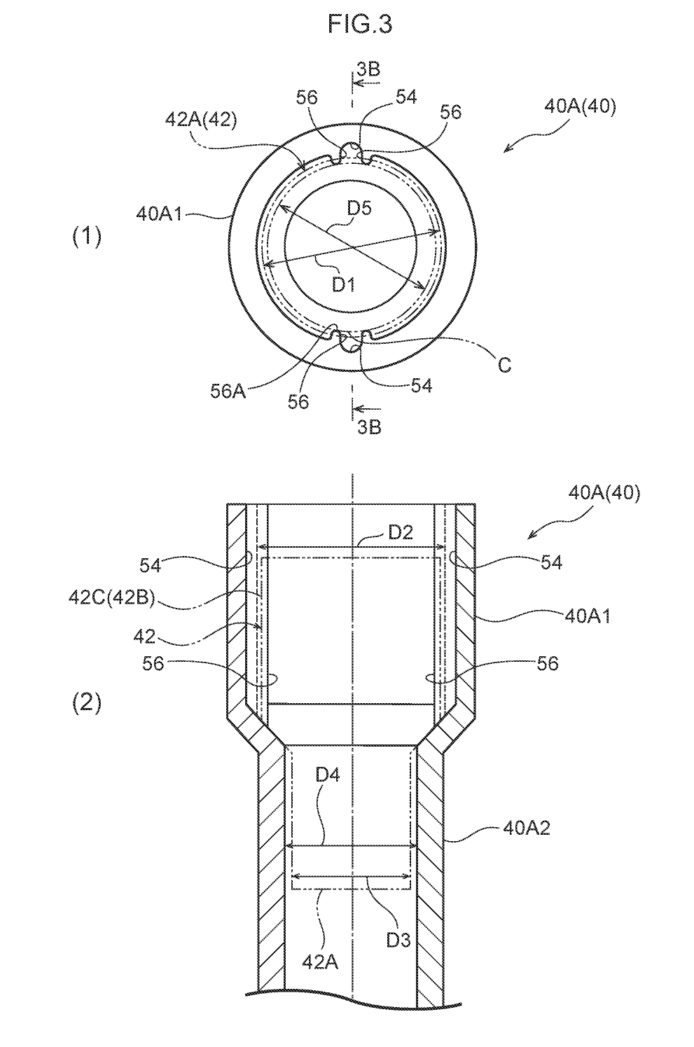

As shown in FIG. 2, the pretensioner mechanism 20 of the present embodiment is a rack-and-pinion type pretensioner mechanism. This pretensioner mechanism 20 is configured to include a pinion 22 that is provided so as to be able to rotate integrally with the spool 14 at the axial direction one side portion of the spool 14, a piston 26 that has a rack 24 that meshes-together with the pinion 22, a micro-gas generator 42 (see FIG. 3) that serves as a gas generating device and generates high-pressure gas instantaneously when operated, and a pipe 40 that accommodates the piston 26 therein and that has a micro-gas generator mounting portion 40A to which the micro-gas generator 42 is mounted.

An O-ring 32 is fit-together with the lower portion of the piston 26. The O-ring 32 is fit tightly to the inner wall of the pipe 40. Due thereto, the gas of the micro-gas generator 42 that has been supplied into the pipe 40 is prevented from coming-out upwardly (toward the pinion 22 side) from the gap between the piston 26 and the pipe 40.

As shown in FIGS. 3(1) and 3(2), the micro-gas generator 42 has a gas generating agent accommodating portion 42A that is formed in a cylindrical shape having a bottom and in which a gas generating agent is filled, and an ignition device accommodating portion 42B that is formed in a cylindrical shape and has an ignition device that generates heat when energized. Further, due to the igniting device generating heat, the gas generating agent is ignited, and, due to the gas generating agent that is filled within the gas generating agent accommodating portion 42A combusting, high-pressure gas is generated instantaneously. Further, due to the pressure of the gas that is generated within the gas generating agent accommodating portion 42A, the gas generating agent accommodating portion 42A is expanded and deformed, and thereafter, breaks, and the high-temperature, high-pressure gas that flows-out from the gas generating agent accommodating portion 42A is supplied to the pipe 40 interior.

The structure of the micro-gas generator mounting portion 40A, which serves as the gas generating device mounting portion and is an important portion of the present embodiment, is described next.

As shown in FIGS. 3(1) and 3(2), the micro-gas generator mounting portion 40A has a first tubular portion 40A1, the majority of which is formed in a cylindrical shape having an inner diameter D2 that is larger than outer diameter D1 of the ignition device accommodating portion 42B of the micro-gas generator 42. Further, the micro-gas generator mounting portion 40A has a second tubular portion 40A2 that is disposed coaxially with the first tubular portion 40A1, and that is formed in a cylindrical shape having an inner diameter D4 that is smaller than the inner diameter D2 of the first tubular portion 40A1 and is larger than outer diameter D3 of the gas generating agent accommodating portion 42A of the micro-gas generator 42.

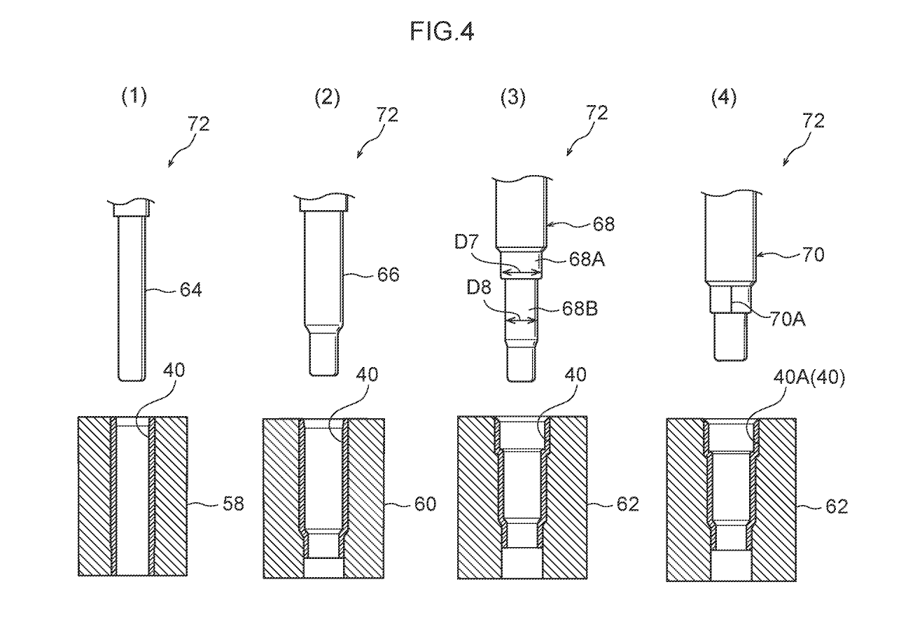

A pair of recessed portions 54 is formed in the inner peripheral portion of the first tubular portion 40A1 (the portion at the side at which the ignition device accommodating portion 42B of the micro-gas generator 42 is disposed). The pair of recessed portions 54 is disposed at a uniform interval along the peripheral direction of the first tubular portion 40A1. The recessed portions 54 are formed by the inner peripheral portion of the first tubular portion 40A1 being pushed by a convex/concave portion forming punch 70 (see FIG. 4(4)) that is described later. Further, convex portions 56, which are convexly-shaped toward the side at which the ignition device accommodating portion 42B of the micro-gas generator 42 is disposed, are respectively formed at the both sides (the both sides in the peripheral direction of the first tubular portion 40A1) of the portions, where the recessed portions 54 are formed, of the inner peripheral portion of the first tubular portion 40A1. Inner diameter D5 of an imaginary circle C, which passes-through distal ends 56A in the projecting-out direction of the convex portions 56, is an inner diameter that is small as compared with the inner diameter D2 of the region, where the recessed portions 54 and the convex portions 56 are not formed, of the first tubular portion 40A1. In addition, the inner diameter D5 of this imaginary circle C is an inner diameter that is smaller than the outer diameter D1 of the ignition device accommodating portion 42B of the micro-gas generator 42.

The structure that forms the micro-gas generator mounting portion 40A is described next by using FIGS. 4(1) through 4(4).

The micro-gas generator mounting portion 40A is formed by using a press device 72 that is configured to include a thickness-increasing die 58, a first pipe-expanding die 60 and a second pipe-expanding die 62 that serve as a die and support the pipe 40 that is formed in the cylindrical shape, a thickness-increasing punch 64, a first pipe-expanding punch 66 and a second pipe-expanding punch 68 that serve as a first punch, and the convex/concave portion forming punch 70 that serves as a second punch.

As shown in FIG. 4(1), the thickness-increasing die 58 and the thickness-increasing punch 64 are for forming the wall-thickness of the end portion, at the one side of the pipe 40 of the material, to a predetermined thickness. The clearance between the thickness-increasing die 58 and the thickness-increasing punch 64 is set to a clearance that corresponds to the aforementioned predetermined thickness.

As shown in FIGS. 4(2) and 4(3), the first pipe-expanding die 60 and the first pipe-expanding punch 66, and the second pipe-expanding die 62 and the second pipe-expanding punch 68, are used in order to make the end portion, which is at the one side of the pipe 40 and has been formed to a predetermined thickness by the thickness-increasing die 58 and the thickness-increasing punch 64, approach a shape that corresponds to the external shape of the micro-gas generator 42, in two stages. Note that, at the second pipe-expanding punch 68, outer diameter D7 of a portion 68A that forms the first tubular portion 40A1 is formed in a cylindrical shape having an outer diameter that is substantially equal to the outer diameter of the ignition device accommodating portion 42B (see FIG. 1) of the micro-gas generator 42, and, at the second pipe-expanding punch 68, outer diameter D8 of a portion 68B that forms the second tubular portion 40A2 is formed in a cylindrical shape having an outer diameter that is substantially equal to the outer diameter D3 (see FIG. 3) of the gas generating agent accommodating portion 42A of the micro-gas generator 42. Due thereto, after the pressing step by the second pipe-expanding die 62 and the second pipe-expanding punch 68 has been carried out, the micro-gas generator 42 can be rotatingly displaced within the end portion at the one side of the pipe 40, in a state in which the micro-gas generator 42 is inserted in the end portion at the one side of the pipe 40.

As shown in FIG. 4(4), the convex/concave portion forming punch 70 is formed in the shape of a block that has corner portions 70A that are formed in shapes (shapes that fit-together with the two recessed portions 54) corresponding to the two recessed portions 54 (see FIG. 2) that are formed at the micro-gas generator mounting portion 40A.

Using the above-described press device 72, first, as shown in FIG. 4(1), the pipe 40 is set at the thickness-increasing die 58, and the thickness is increased while the end portion at the one side of the pipe 40 is nipped-in between the thickness-increasing die 58 and the thickness-increasing punch 64 (thickness-increasing step). Due thereto, the wall thickness, of the end portion of the one side of the pipe 40, of the material is formed to a predetermined thickness.

Next, as shown in FIGS. 4(2) and 4(3), the end portion at the one side of the pipe 40 is nipped-in between the first pipe-expanding die 60 and the first pipe-expanding punch 66, and, thereafter, the end portion at the one side of the pipe 40 is nipped-in between the second pipe-expanding die 62 and the second pipe-expanding punch 68. Due thereto, the end portion at the one side of the pipe 40 is gradually made to approach a shape that corresponds to the external shape of the micro-gas generator 42 (a first pipe-expanding and second pipe-expanding step that serves as a first step).

Next, as shown in FIG. 4(4), due to the convex/concave portion forming punch 70 being inserted in the end portion of the one side of the pipe 40 that is in a state of being set in the second pipe-expanding die 62, the micro-gas generator mounting portion 40A that has the recessed portions 54 and the convex portions 56 is formed (convex/concave portion forming step that serves as a second step).

Then, finally, the micro-gas generator 42 is inserted in the micro-gas generator mounting portion 40A, and the axial direction proximal end portion of the micro-gas generator mounting portion 40A is caulked to the radial direction inner side. Due thereto, the micro-gas generator 42 is fixed to the micro-gas generator mounting portion 40A (micro-gas generator fixing step that serves as a third step).

Through the above-described steps, the micro-gas generator mounting portion 40A of the pipe 40 that structures a portion of the webbing take-up device 10 of the present embodiment is formed, and the micro-gas generator 42 is fixed to the micro-gas generator mounting portion 40A. Further, due to the respective structural parts, such as the pipe 40 to which the micro-gas generator 42 is fixed, and the like, being assembled together, the webbing take-up device 10 of the present embodiment is manufactured.

### Operation and Effects of Present Embodiment

Operation and effects of the present embodiment are described next.

As shown in FIG. 1, in the present embodiment, the webbing 12 is worn by the body of an occupant of the vehicle due to the webbing 12 being pulled-out from the spool 14.

Further, in the state in which the webbing 12 is worn by the body of the occupant of the vehicle, when the locking mechanism 18 operates at the time of an emergency of the vehicle, rotation of the spool 14 in the pull-out direction is limited. As a result, pulling-out of the webbing 12 from the spool 14 is limited, and the body of the vehicle occupant, which starts to move toward the vehicle front side, is restrained by the webbing 12.

Further, as shown in FIG. 3, when the gas that is generated by the micro-gas generator 42 is supplied into the second tubular portion 42 of the cylinder 30 due to the micro-gas generator 42 being operated at the time of an emergency of the vehicle, as shown in FIG. 2, the piston 26 is moved toward the upper side. Then, the rack 24 of the piston 26 that has moved meshes-together with the pinion 22, and the pinion 22 is rotated in the take-up direction. Due thereto, the spool 14 is rotated in the take-up direction by a predetermined number of rotations, and a predetermined length of the webbing 12 is taken-up onto the spool 14. As a result, slack of the webbing 12 that is worn by the vehicle occupant is eliminated, and the restraining force of the vehicle occupant by the webbing 12 is increased.

Here, as shown in FIGS. 3(1) and 3(2), in the present embodiment, the recessed portions 54 whose micro-gas generator 42 sides are open, are formed at the micro-gas generator mounting portion 40A at which the micro-gas generator 42 is mounted, and the convex portions 56 that are formed in shapes that are convex toward the micro-gas generator 42 side are formed along the recessed portions 54. Further, due to the ignition device accommodating portion 42B of the micro-gas generator 42 anchoring on the convex portions 56, rotational displacement of the micro-gas generator 42 with respect to the micro-gas generator mounting portion 40A is restricted. Due thereto, in the present embodiment, displacement of the micro-gas generator 42 with respect to the micro-gas generator mounting portion 40A can be restricted. As a result, the connector of a wire that is provided at the vehicle can be mounted to the micro-gas generator 42 in a predetermined attitude.

Further, in the present embodiment, the convex portions 56, on which the ignition device accommodating portion 42A of the micro-gas generator 42 is anchored, can be formed easily by inserting the convex/concave portion forming punch 70 into the end portion at the one side of the pipe 40. This point can devise simplification of and shortening of time of the manufacturing processes, as compared with a case in which a step for forming a portion, on which the ignition device accommodating portion 42B of the micro-gas generator 42 is anchored, is provided separately after the step of machining by the press device 72 has been carried out. Further, in the present embodiment, by structuring the respective punches (the thickness-expanding punch 64, the first pipe-expanding punch 66, the second pipe-expanding punch 68 and the convex/concave portion forming punch 70) to move in the same direction, the pipe 40 which is the work piece can be conveyed easily, and the cycle time can be shortened, and machining can be carried out at the same equipment.

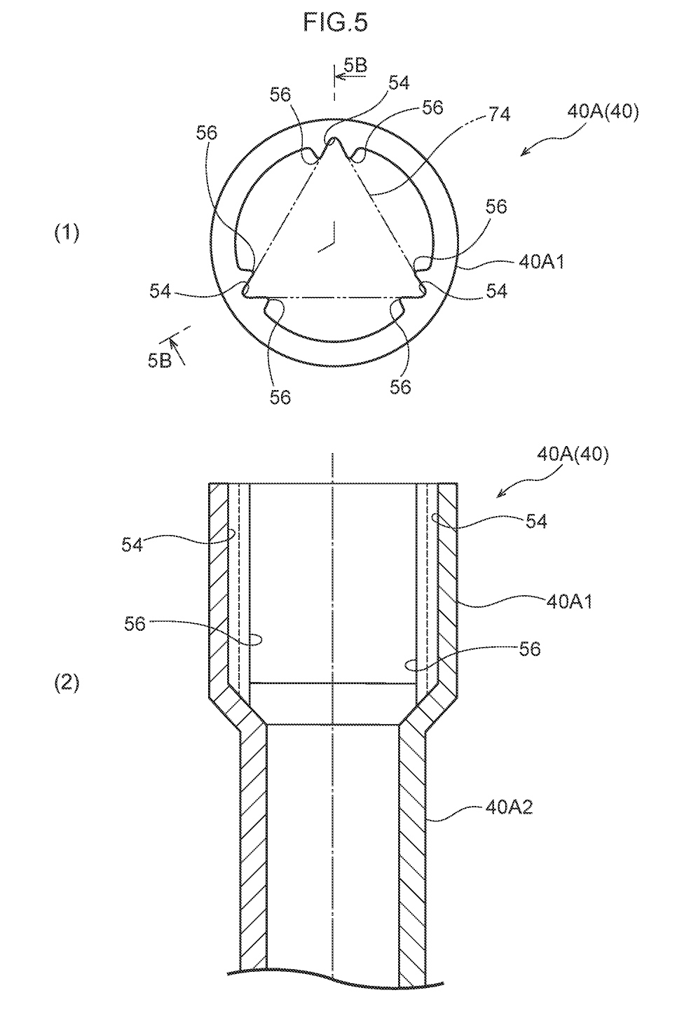

Note that the present embodiment describes a structure in which, by forming the two recessed portions 54, the convex portions 56 are formed respectively at the both side portions of the two recessed portions 54. However, the present invention is not limited to this. For example, as shown in FIGS. 5(1) and 5(2), there can be a structure in which, by using a triangular punch 74 that serves as the second punch and that is formed in a triangular cross-section, three of the recessed portions 54 are formed, and the convex portions 56 are formed respectively at the both side portions of these three recessed portions 54. Further, the recessed portions 54 and the convex portions 56 may be formed at only a portion in the axial direction of the first tubular portion 40A1.

Although an embodiment of the present invention has been described above, the present invention is not limited to the above, and can of course be implemented by being modified in various ways other than the above within a scope that does not depart from the gist thereof.

The disclosure of Japanese Patent Application No. 2016-122764 that was filed on Jun. 21, 2016, is incorporated in its entirety by reference into the present specification.

1. A webbing take-up device comprising:
a spool at which a webbing, which is worn by a vehicle occupant, is taken up by the spool being rotated in a take-up direction; and
a pretensioner mechanism that has: a gas generating device that is configured to generate gas when operated, and a gas generating device mounting portion, that is formed in a shape of a tube into which the gas generating device is inserted and that is provided with a recessed portion that is open toward a side of the gas generating device and a convex portion that is formed along the recessed portion and is convexly-shaped toward the side of the gas generating device and at which a portion of the gas generating device is anchored, the pretensioner mechanism rotating the spool in the take-up direction owing to the gas generating device being operated at a time of an emergency of a vehicle.

2. A method of manufacturing the webbing take-up device of claim 1, the method comprising:
using a die that supports a pipe formed in a tube shape, a first punch that is formed in a shape corresponding to an external shape of the gas generating device, and a second punch having a portion formed in a shape corresponding to the recessed portion;
forming a portion of the pipe into which the gas generating device can be inserted, by setting the pipe at the die and nipping the pipe between the die and the first punch;
forming the gas generating device mounting portion of the pipe, which has the recessed portion and the convex portion, by inserting the second punch into the portion of the pipe into which the gas generating device can be inserted; and
fixing the gas generating device to the gas generating device mounting portion by inserting the gas generating device into the gas generating device mounting portion.

3. The webbing take-up device of claim 1, wherein the recessed portion comprises a pair of recessed portions.

4. The webbing take-up device of claim 3, wherein the pair of recessed portions is disposed with a uniform interval therebetween along a peripheral direction of the gas generating device mounting portion.
